(19) United States
(12) Patent Application Publication
(10) Pub. No.: US 2016/0221101 A1
(43) Pub. Date: Aug. 4, 2016

(54) DEVICE AND METHOD FOR WELDING AT LEAST ONE WORK PIECE

(71) Applicant: BLUEMARINE OFFSHORE YARD SERVICE B.V., JD Rotterdam (NL)

(72) Inventors: Andrian-Ionut SINGURAN, Delft (NL); Nicola PAMBAKIAN, Delft (NL)

(21) Appl. No.: 14/917,313

(22) PCT Filed: Sep. 17, 2014
(86) PCT No.: PCT/NL2014/050633

§ 371 Date: Mar. 8, 2016

(30) Foreign Application Priority Data
Sep. 17, 2013 (NL) 2011452

(51) Int. Cl. B23K 9/073; B23K 9/028; B23K 9/08

(52) U.S. Cl. CPC B23K 9/073; B23K 9/08; B23K 9/0282

(57) ABSTRACT

A method of welding at least one work piece in at least one location is disclosed, using at least one arc generating element. The method includes welding the work piece at the location of the arc generating element, moving the arc generating element along a path of welding; and during welding, decreasing magnetic fields in or between the work piece(s), by locally suppressing magnetic fields at least partially at or near the location of the arc generating element. A welding device is disclosed including a carriage adapted to move along a path of welding relative to the work piece, including a holder accommodating at least an arc generating element; and a device on the carriage, adapted to locally decrease magnetic fields in or between the work piece(s), by locally suppressing magnetic fields at least partially at the location of the arc generating element.

The present invention relates to a method of welding at least one work piece in at least one location and a welding device.

Welding processes, and especially but not exclusively DC based welding processes, are hampered by magnetic field in and emanating from work pieces.

To address these issues, according to embodiments of the present invention a method and a device are provided, which have been developed to reduce detrimental effects resulting from magnetic fields in and from work pieces.

In an aspect of the present invention, a method is provided of welding at least one work piece in at least one location, using at least one arc generating element, such as a cathode, the method comprising:
welding the work pieces at the location of the arc generating element;
moving the arc generating element along a path of welding and therewith the location of welding; and
during welding, decreasing magnetic fields in the work piece or between work pieces, by locally suppressing magnetic fields at least partially at the location of the arc generating element and therewith of welding.

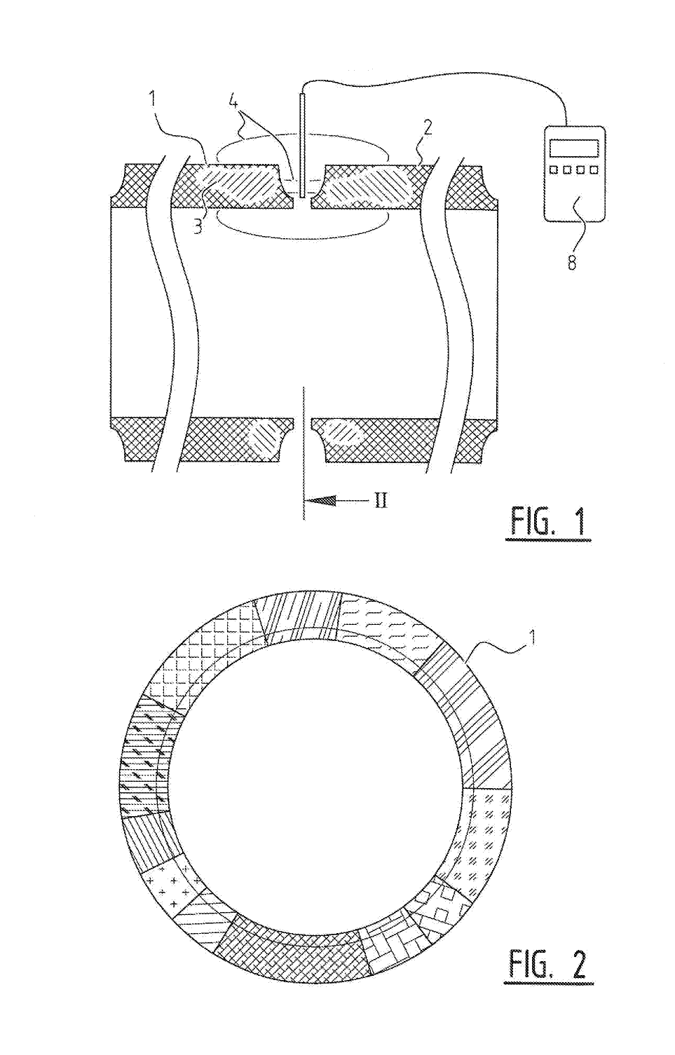

When current discharges are used for welding work pieces to each other, or to close tears, rifts or breaks in a single work piece, magnetization of the work piece to be welded is a well known, well documented and commonly encountered phenomenon. Magnetic flux in or at the surface(s) of the welding junction may distort the plasma medium that is the build-up path for the current discharge required for the welding operation, and quality of a resulting weld may be affected thereby. FIG. 1 exhibits that magnetic fields 3 can occur in material to be welded. Such magnetic fields can have one or more of several different causes, such as magnets used for lifting up or setting down pipes, the Earth's magnetic field, and the like. In particular in FIG. 1, two abutting ends of pipe pieces 1, 2 are exhibited as an embodiment of two work pieces to be welded. Magnetic Field lines 4 in FIG. 1 will then occur and bridge a gap between the near abutting pipe ends of the pipes 1, 2 in FIG. 1, as well as around the outsides of the pipes 1, 2. In a frontal view of FIG. 2, a typical end of pipe 1 is exhibited to comprise many different zones, each having a specific magnetic character or property, in particular varying flux intensities. The magnetic properties of the end of pipe 1 are shown in FIG. 2 to vary around the circumference thereof, which is schematically represented in FIG. 2 by different shadings in the material of the end of pipe 1, and also the same is the case for the other pipe end of near abutting pipe 2, at least just before a welding process is performed. As a consequence, orientations or directions of the flux lines for both pipe ends of pipes 1, 2 in a near abutting configuration vary from region to region around the circumference of the pipes 1, 2.

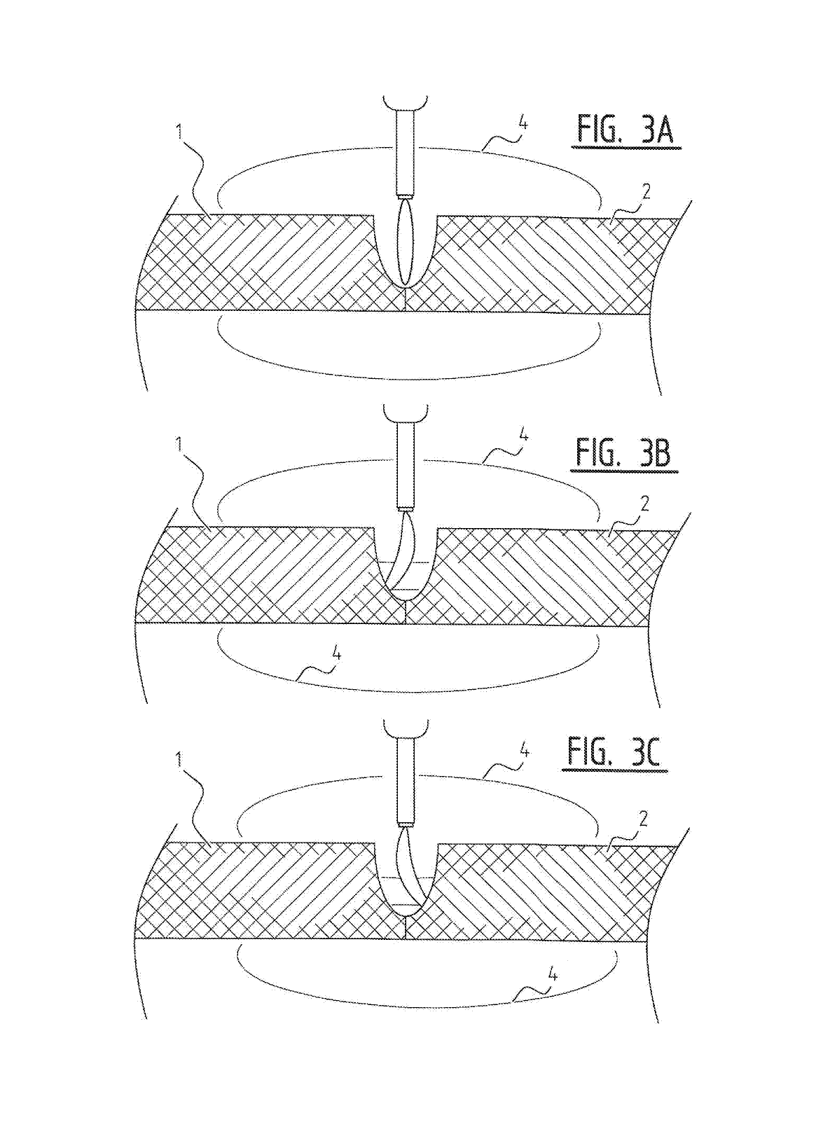

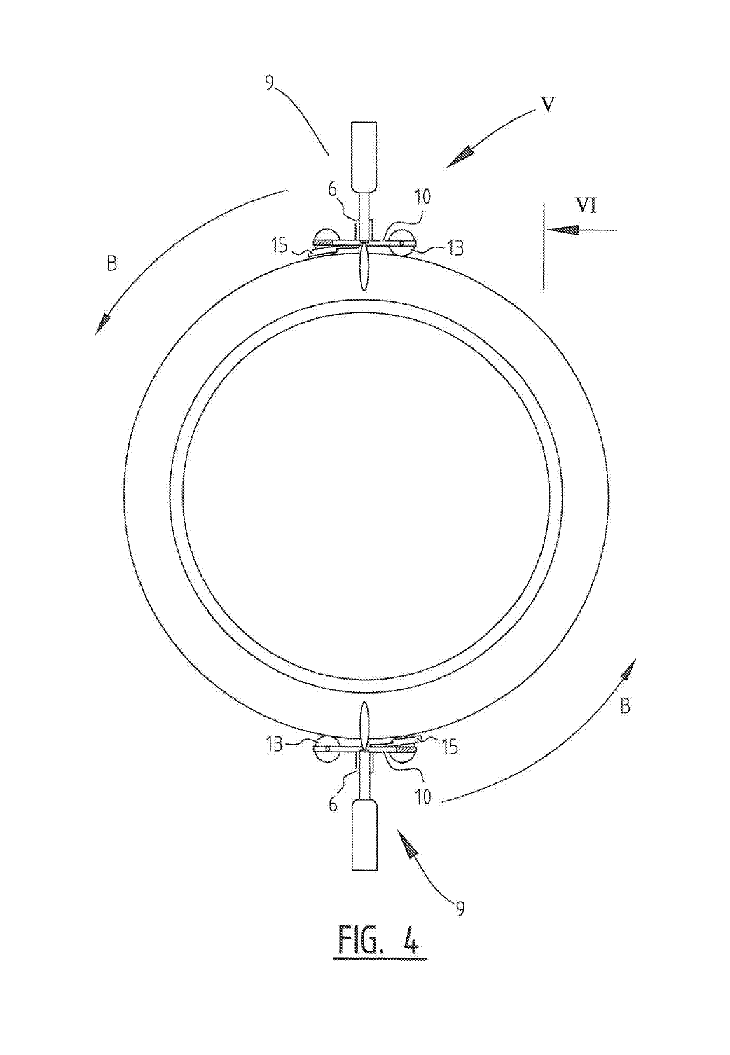

When magnetic fields are relatively strong, an effect called ‘arc blow’ can occur. When ‘arc blow’ occurs (as exhibited in FIGS. 3A-3C), an arc generated by for instance a cathode will bend from an intended orientation, after which the welding process should be stopped, or burn up of material of the work piece will occur and a weld will be created at a wrong place relative to the location of welding or the path along which a welding arc generating element, such as an arc generating cathode, is made to move. In any case, ‘arc blow’ will at least slow down welding production. In FIG. 3A, a desired orientation of a welding arc is shown, whereas in FIG. 3B a deviation to the left is shown, and in FIG. 3C a deviation to the right is shown of welding arcs, relative to the ideal situation of FIG. 3A. It is again emphasized here that the phenomenon of arc blow as shown in FIGS. 3B and 3C is caused by random magnetic fields. The pipes 1, 2 can be carbon steel and/or cladded pipes having a cladding layer on the in- or outside of the pipe. It will be immediately evident to materials expert, that more and other materials can also exhibit arc blow, when welded. In particular, a cladding layer will worsen the effect of the magnetic flux in the plasma medium that is the build-up path for the welding junction.

Welding production is referred to here as a process in which welding robot or machines are used for welding processes that normally follow a predetermined path, and can be repetitively performed.

Such a path may be oriented along abutting work pieces for welding the two work pieces together, like the situation of FIG. 1, or a path along a break or rift, where a single work piece is to be repaired through welding.

A possible countermeasure against ‘arc blow’ is to increase the current intensity of welding, particular DC welding, and/or to reduce an arc length. However, in doing so, considerable care must be taken not to increase the welding intensity to such an extent, that damage to the work pieces occurs, rendering the weld unreliable.

Another possible countermeasure against arc blow caused by magnetization in or at the welding junction is, for instance, to revert to AC welding. Especially, though not exclusively, in case of AC welding, it is considered possible to arrange a coil around at least one of the work pieces to, where possible, influence the magnetic field. Thus the entire pre-assembly of the pipe ends of pipes 1, 2 in FIG. 1 is to be wrapped in said coil. It is to be noted that this is only possible when ‘closed section’ items are welded, such as pipes, and can't be applied to flat layers.

However, rather than reverting to often less desirable AC welding, and only under specific circumstances, DC welding is most often preferred over AC welding, as DC welding offers important advantages over AC welding. For instance an arc reaches deeper into material to be welded during the welding process. Further, DC welding results in sensibly smoother weld, and thus require less finishing operation(s) after the welding process. Consequently, DC welding is in many applications preferred.

In relation to such prior art, it is noted here that EP-0251423 teaches the use of a large coil set around the work piece or a pair of elongate coils arranged along a considerable distance of a weld. Such a coil set, for instance, on the pipes 1, 2 in FIG. 1, serves to cancel or suppress magnetic fields by imposing a strong field and thereby set or overpower the original magnetic field that could cause the arc blow. This approach of wrapping entire pipe ends (for which this approach is exclusively applicable) in a coil requires considerable processing steps to wrap the pipe ends in the coil(s) and after welding remove the coil(s) again. Further, this approach is only applicable when implementing a welding process based on a single weld location. Namely, such an approach involves generating a global field, which may result in a magnetic field and cancellation of existing magnetic fields in some locations along the weld path, but may equally increase the resulting magnetic field in other locations along the weld path. In some specific weld processes, two or more welding arc cathodes are preferably employed to simultaneously weld pipe ends at distant locations around the circumference of the pipe ends. Thereby a faster total welding process can be achieved, where stress in the material of the pipe ends after welding can be reduced, precisely because of the number of simultaneously executed partial welding processes. With the approach of a single huge coil, simultaneous cancellation of magnetic fields at both or more than two locations, where welding devices are simultaneously employed, is near impossible to achieve.

Further, in this approach to the issue of arc blow, where pipe ends are wrapped in coils to generate a strong field, the inherent magnetic field is not—in fact—cancelled, but instead homogeneously shifted in a positive or negative direction. Consequently, with a focus in this approach on one welding spot or location, a desired embodiment allowing simultaneous welding at different locations, for example distributed welding locations around the circumference of pipe ends, this approach is not suitable or able to improve magnetic field conditions at more than one welding location, so it will not be possible that magnetic field properties in two points along the section with different magnetizations are ever improved simultaneously.

In addition, reference is made here to the prior art disclosure in DE-645938, teaching the shaping or forming of a welding arc during welding along a weld line in, on or between work pieces. This disclosure relates to an archaic system and method of welding, since the objective is to stabilize the arc using magnetic field across the arc, without consideration for any spurious magnetic fields in the material of the work piece. In contrast, modern welding methods and systems are based on controlling the arc to oscillate from side to side relative to a direction of the weld line. The disclosure of DE-645938 lacks a proper control to achieve this and must have been entirely reliant on visual detection and control, and consequently only stabilizing a weld arc in size, shape and orientation would have been feasible, and would then still have been hampered by local or stray or spurious fields in the material of the work piece to be welded. More in particular, no method or system according to this disclosure can be employed for automatic welding of pipes, since the surface oriented magnets disclosed in DE-645938 cannot be expected to generate fields to positively influence the working area of a welding arc, more in particular deep inside a bevel between work pieces.

WO-2011/131985 teaches a stationary device for stationary influencing of fields on a single work piece.

Yet further reference is made to U.S. Pat. No. 6,617,547 and U.S. Pat. No. 3,626,145, which teach the use of controllable electromagnets based on detections made employing electro-optical elements and/or Hall sensors, wherein the electromagnets are oriented across a weld arc and over a surface of a work piece, to generate a controlling field through an air gap locally to shape/form the resulting arc with the field that is in particular perpendicular to the direction of the arc, just like the objective of DE-645938, without considering local, spurious or stray fields originating from the (interior of the) material of the work piece(s).

In contrast, according to the present disclosure, spurious, local or stray fields inside material of the work piece are cancelled to diminish the influence thereof on the weld arc, by applying an opposite field, using the controllable magnetic elements and detections from an arbitrary type of sensor, capable of detecting such stray, spurious or local fields originating from the interior of the material of the work piece(s) to be welded.

As a matter of fact, rather than attempting to directly influence the shape or orientation of a welding arc, in an embodiment of welding work pieces, such as pipe segments, together with a bevel between the pipe segments, stray and/or spurious fields at the bottom of the bevel are suppressed and consequently, quality of a weld is improved.

In below described embodiments, local influence is exerted to reduce locally and/or locally suppress magnetic fields in work pieces. Local countermeasures can be used to combat for instance arc blow, enable the implementation of multiple welding point, allow DC welding without having to crank up the intensity thereof, and can be implemented with planar work pieces.

In embodiments a way is proposed to solve the magnetization problem by influencing the magnetization of the work pieces by external sources of magnetism (e.g., permanent magnets or small coils). Opposing magnetic fields (e.g., North vs. North of magnets), no matter whether coming from a permanent magnet or induced by coils, tend to magnetize the two work pieces to be welded, producing the positive effects that: the flux density encountered in the junction of the two sides is reduced, or even cancelled; the behavior of the magnetic field lines in the junction is more controlled and predictable, making test qualifications more effective; and this approach allows local demagnetization of the work pieces, and therefore allows multiple areas to be welded simultaneously.

In relation to control it is noted here that embodiments allow easy implementation and presents several possibility of configurations and degrees of freedom, for instance in relation to the number of magnets/induction coils to be used. For instance in relation to magnetic orientations, it is noted that locally applied coils and/or magnets can be positioned facing each other with North, South or North/South section sides. Further, magnets/coils can be arbitrarily positioned with respect to distances and geometrical orientations, which allows various different configurations. It is further noted that embodiments can be applied to demagnetize work pieces to be welded together of various shapes and materials; the sections may be unequal, even dissimilar, in any of the two attributes.

Once a structure with magnetic sources is fixed, the magnetic sources' position can be fine-tuned for complete or at least further cancellation of magnetic fields, in particular though not exclusively for those cases where geometrical imprecisions and strong external influences prevent cancellation from occurring in the first place. Given a proper Gauss-meter, or any other instrument capable of revealing the magnetic field, a closed-loop system including a control acting on a position of the magnets or current running through coils can be made to improve local magnetic cancellation. A meter can normally not be arranged in the active region of the arc, so that a control is preferably able to use meter detection results, predict an appropriate current through a coil and/or position of magnets, and implement corresponding settings for when the arc generating element (often a cathode) arrives at the place where the meter measured the magnetic field. Normally such a meter will then be arranged ahead of a trajectory or path followed by the arc generating element.

Consequently, embodiments allow DC welding, which is often preferred over AC welding, despite limitations of DC welding with respect to inherent magnetism of work piece(s). Locally implemented countermeasures for reducing or suppressing magnetic fields allow the use of a mounted structure with magnetic sources to be much smaller, cheaper and more portable, compared to other demagnetization methods using large coils to be wrapped around work pieces and current sources, as known from, for instance, EP-0251423. Thus embodiments allow, with a proper design, application to almost any kind of work piece exhibiting magnetism. Finally it is noted that closed-loop systems can be readily be realized in multiple ways, to enhance the effects described above even further, an even in the course of the welding process being executed.

Embodiments can be implemented in several modes of operation for welding. Merely by way of illustration reference is made here to demagnetization of pipes' junctions for offshore pipelining.

Following the above indications of embodiments in more general terms, below embodiments will be described in more detailed manner, referring to the appended drawings, in which exemplary embodiments are shown, to which the present invention is by no means intended to be restricted, in view of the appended definition of the invention in the claims. In the drawings, the same or similar reference numbers can be employed for the same or similar elements, components, expects or steps of different embodiments in the drawings. The drawings show in:

FIG. 1 an explanatory view of phenomena in pipe ends of pipes to be welded;

FIG. 2 a frontal view in the direction of arrow II in FIG. 1;

FIGS. 3A-3C explanatory views with respect to the phenomenon of arc blow;

FIG. 4 an schematic representation of an embodiment in operation for welding pipe ends of pips to each other;

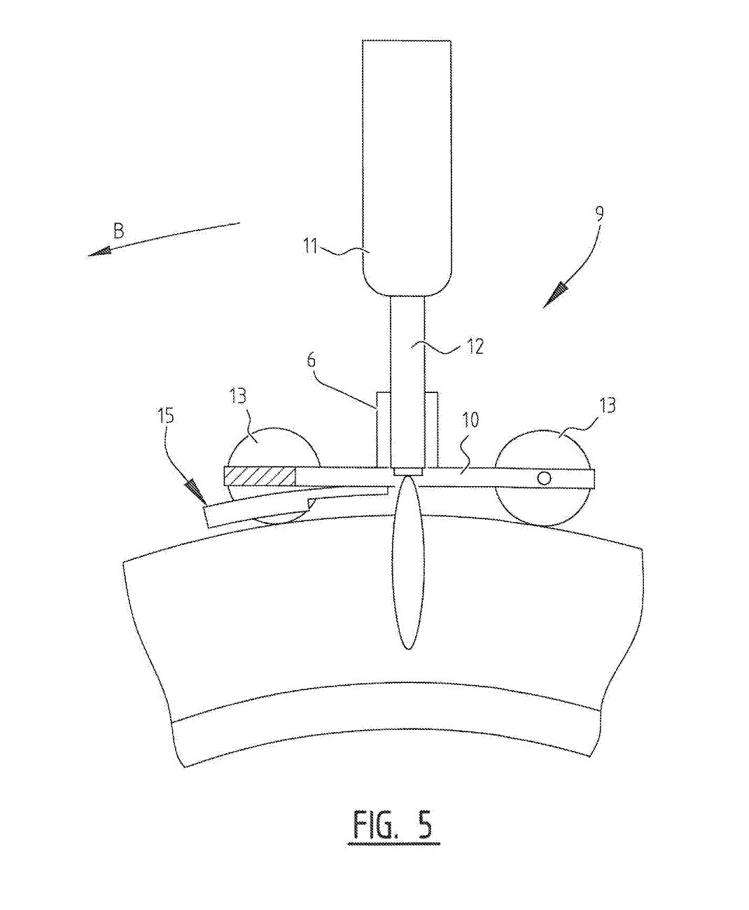

FIG. 5 a detail of the view of FIG. 4;

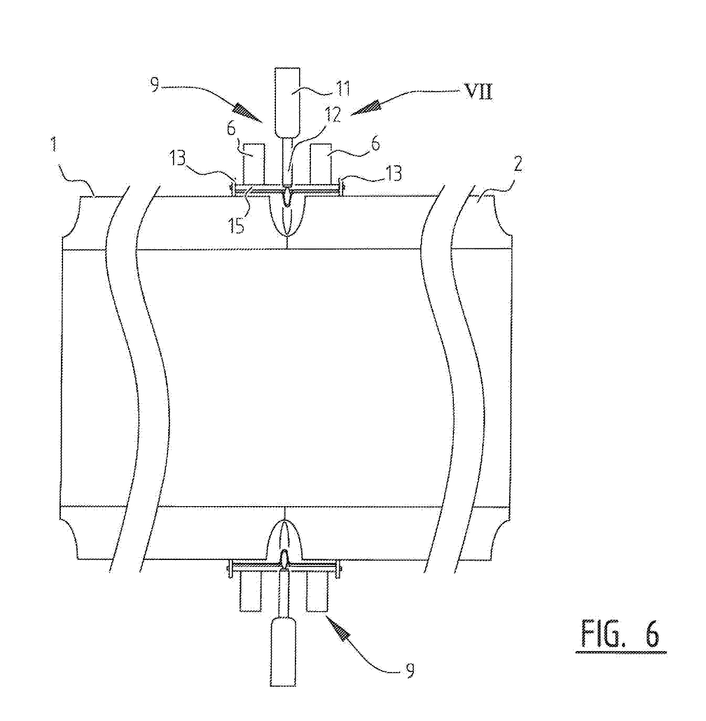

FIG. 6 a side view along arrow VI in FIG. 4;

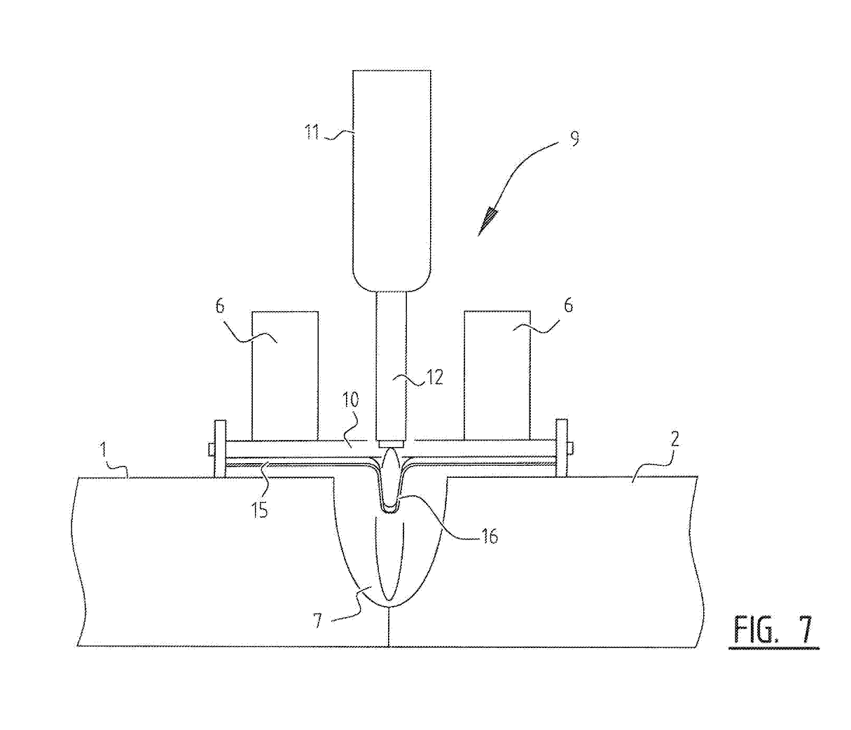

FIG. 7 a detail of the view of FIG. 6;

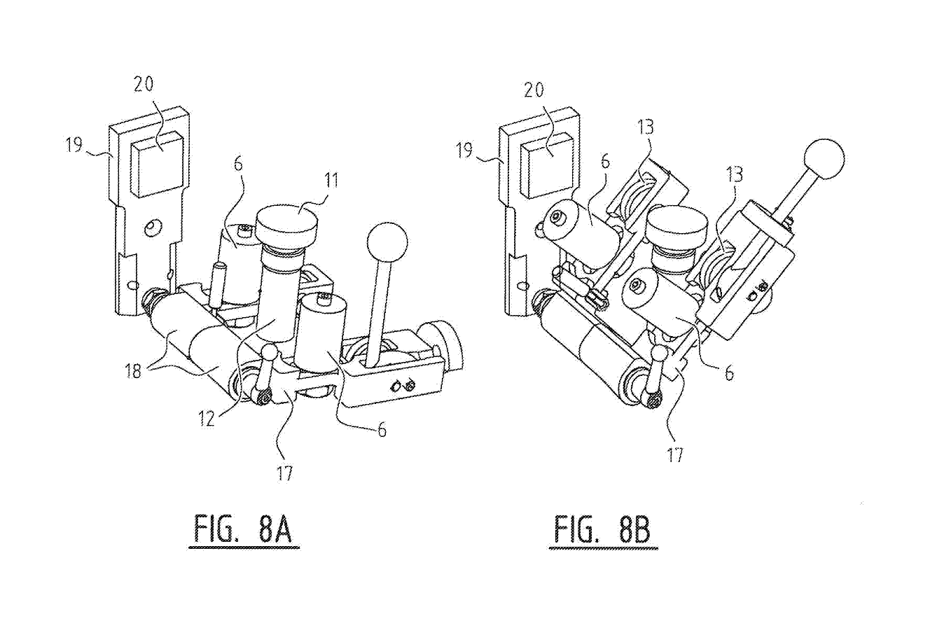

FIGS. 8A and 8B perspective views of a less schematically represented embodiment than FIGS. 4-7;

FIG. 9 a schematic representation of the effect of an embodiment; and

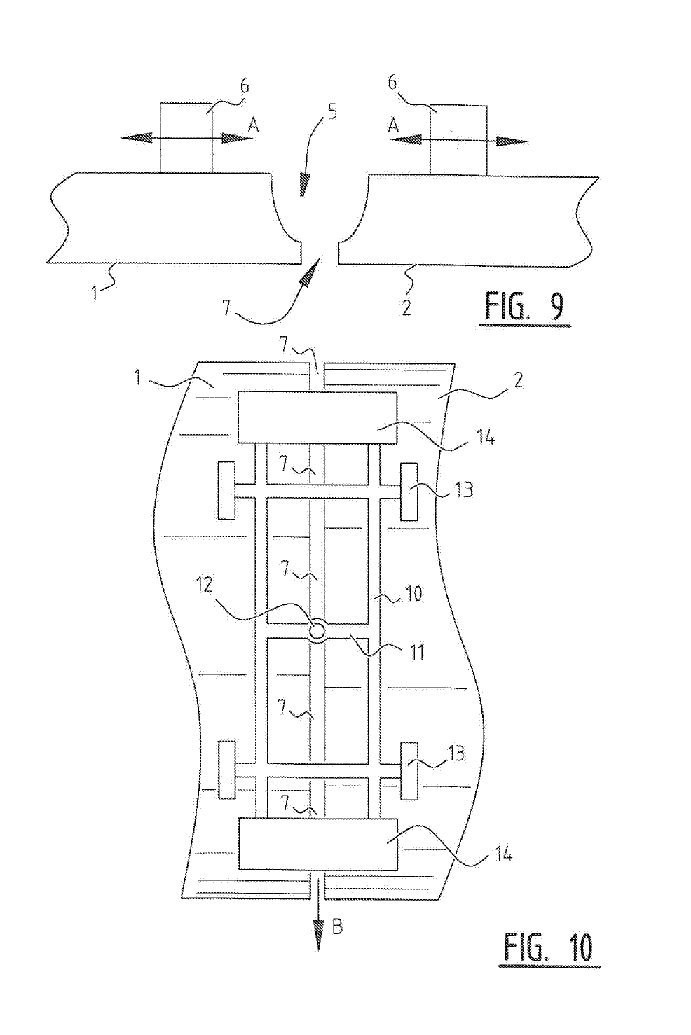

FIG. 10 an schematic representation of an alternative embodiment.

FIG. 9 exhibits in schematic representation an explanation of the principle underlying the embodiments in FIGS. 4-9. Here, two permanent magnets 6 are arranged opposite one another relative to a joint to be welded. The permanent magnets 6 are oriented towards the material of the work pieces formed by pipe ends 1, 2 to impose a magnetic field in the material of the pipe ends 1, 2, to which the magnetic fields within the material of the pipe ends 1, 2 adapt, as indicated in FIG. 9. As a result, the considerable magnetic fields 4 across joint 7 are reduced to a week magnetic field 5. This reduction is especially though not exclusively achieved at the bottom of the beveled weld area at or above joint 7 in FIGS. 7 and 9.

The permanent magnets 6 do not need to be positioned in a stationary manner, relative to the joint 7. In a specific embodiment, positioning of each of the permanent magnets 6 can be changed relative to the joint 7 in the direction of arrow A. Thereby optimization of the reduction of remaining magnetic fields 5 across the joint 7 can be achieved. Each of the permanent magnets 6 can in a specific embodiment the positioned individually from the other of the permanent magnets 6, or alternatively, the magnets 6 can be simultaneously adapted imposition, relative to the joint 7 in the sense, that both magnets 6 can be displaced away from the joint, or closer to the joint 7. In another embodiment coils can be used instead of the permanent magnets 6, with the same effects as depicted in FIG. 9. However, minimization of remaining magnetic field 5 across joint 7 can then be achieved by varying currents to be sent through the coils.

FIG. 1 exhibits a Gauss meter 8, with which it is possible to measure magnetic fields 4, 5 at the joint 7. Likewise, a Gauss meter can be employed in the configuration of FIG. 9. A controller can be provided to use measurement results from meter 8 and determine an optimal position of magnets 6 or alternatively coils relative to the joint 7, or an optimal current through each of the coils to induce magnetic fields to be input into the material of pipe ends 1,2.

FIGS. 4-7 exhibit a more detailed embodiment than the schematic representation of FIG. 9. FIGS. 4 and 6 exhibit a welding operation, in which two welding devices 9 or in operation, at opposite sides of a pre-assembly of two pipes 1, 2, of which the pipe ends are to be welded together. Each of the welding devices 9 comprises a carriage 10 adapted to move along a path of welding relative to the joint 7 between the two pipes 1, 2, each forming a work piece. The carriage 10 of each welding device 9 has a holder 11 for accommodating an arc generating cathode 12. The arc generating cathodes are connected to power sources, in particular current sources, which are not depicted here for clarity reasons. The carriages 10 are arranged on running wheels 13 for the carriages to closely follow a curvature, in this case of pipes 1, 2, when moving in the direction of arrows B. Therewith a location of welding is moved along the desired part of the joint between the pipe ends of pipes 1, 2.

In the embodiment of FIGS. 4-7, a device on the carriage, which device is adapted to locally at the carriage decrease magnetic fields between work pieces, by locally suppressing magnetic fields at least partially at the location of the arc generating element and therewith of welding, is formed by the magnets 6 having the effect/functionality, as described above in conjunction with FIG. 9. Alternatively or additionally, high permeability connectors or cylinders 14 can be arranged on the carriage to contact the pipe ends on either side of the joint 7, as shown in FIG. 10.

In the embodiment of FIGS. 4-7, a shield plate 15 is connected to the carriage 10, at the front thereof in relation to the movement direction according to arrow B. The shield plate 15, as shown in FIG. 7, comprises a depression or indentation 16, which extends into the joint 7. If the shield 15 is positioned to be in contact with the material of the pipes 1, 2, and is manufactured from material exhibiting a relatively high permeability with respect to magnetic fields, this shield plate 15 can perform the function of the connector 14, referred to above in relation to FIG. 10.

The permanent magnets 6 or alternatively or additionally coils are arranged on either side of the joint 7, as shown for instance in detail in FIG. 6, very near to the arc generating cathode 12. Consequently, their influence on the magnetic fields, as depicted in FIG. 9, is very local and highly controllable.

FIGS. 8A and 8B exhibit a more detailed version of an embodiment of a welding device comprising a carriage in the form of a swivel frame 17 with rollers 18 at the front end thereof. The rollers 18 are rotatable around a lying axis, which is mounted to a bracket 19. The swivel frame 17 is arranged for rotation about the lying axis, which carries the rollers 18. Consequently, the swivel frame 17 can be swiveled between the two orientations in respectively FIG. 8A and FIG. 8B, relative to bracket 19. The bracket 19, or another part of the configuration, can accommodate a controller 20, the controller 20 can be arranged to act on an adapter as described above in conjunction with FIG. 9. The adapter can vary currents through coils and/or positions of permanent magnets 6 in the manner, described in relation to FIG. 9. To enable the controller to perform driving the adapter, measurement results are received from for instance the Gauss meter 8 in FIG. 1. The Gauss meter 8, which is a specific embodiment of a magnetic field meter, is adapted to measure a magnetic field at a plurality of points along the path of moving the arc generating element 11. This can for instance be achieved by arranging the sensor of the Gauss meter 8 on the carriage 10. The controller 20 is then adapted to determine, based on magnetic field measurement results from the magnetic field meter, a measure of influencing from the at least one position, that is expected to suppress the magnetic field at the location of the arc generating element for each of the points along the path of movement of the arc generating element as the arc generating element approaches or is at the points. Based on this determination, the controller 20 is adapted to drive the adapter for adjusting the measure of influencing to a determined measure of influencing as the arc generating element reaches each of the points along the path, where the sensor of the Gauss meter has determined the magnetic field.

Many additional and/or alternative embodiments will immediately become evident to the person skilled in the relevant art, after having been confronted with the above description and the disclosure of embodiments. All such additional and/or alternative embodiments reside within the scope of protection for the embodiments as defined in the appended claims, unless such additional and/or alternative embodiments substantially differ from the definitions in the appended claims, in particular the independent claims.

1. A method of welding at least one work piece in at least one location, using at least one arc generating element, the method comprising:
welding the at least one work piece at a location of the arc generating element; and
moving the at least one arc generating element along a path of welding defined by an open joint and moving therewith, the location of welding, the at least one arc generating element including two arc generating elements and the
welding including welding the at least one work piece simultaneously at two locations along the path of welding using the two arc generating elements;
decreasing magnetic fields in the open joint or between the at least one work piece, during the welding, by at least partially suppressing magnetic fields locally at each of the locations of the arc generating elements individually, wherein the locally suppressing magnetic fields includes magnetizing material of the at least one work piece at or near each of the locations of the arc generating elements individually using controllable magnetic elements oriented into the surface of the at least one work piece at positions next to each of the locations individually;
measuring a magnetic field at a plurality of points in the respective paths of moving the arc generating elements using a magnetic field meter;
determining a measure of influencing from the positions, expected to suppress magnetic fields at each of the locations of the arc generating elements individually for the points along the respective paths of movement of the arc generating elements as the arc generating elements approach or are at the points; and
individually adapting the measure of influencing to a determined measure of influencing for each of the arc generating elements, as the arc generating elements reach the points along their respective paths.

2. The method of claim 1, wherein the locally suppressing of the magnetic fields comprises magnetizing material of the at least one work piece on opposing sides relative to the location of the arc generating elements and of the welding.

3. The method of claim 1, wherein decreasing magnetic fields in or between the at least one work piece includes influencing the magnetic fields from at least one position at a relatively short distance from each of the locations of the arc generating elements individually.

4. The method of claim 3, further comprising:
adjusting intensity of the influence at or near the position from the relatively short distance from the arc generating elements.

5. The method of claim 3, further comprising:
varying the relatively short distance from the position of influence to the locations of the arc generating elements.

6. The method of claim 1, wherein the locally suppressing of the magnetic fields at least partially at each of the locations of the arc generating elements individually comprises generating demagnetizing local magnetic fields locally in relation to each of the locations of the arc generating elements individually.

7. The method of claim 1, further comprising:
shielding at least a portion of the path of moving the arc generating elements, using a shield.

8. The method of claim 1, wherein the locally suppressing of the magnetic fields at least partially at each of the locations of the arc generating elements individually comprises connecting parts of the at least one work piece in the vicinity of each of the weld locations individually using at least one connector of a material exhibiting a high permeability to magnetic fields to divert the magnetic fields to flow through the connector.

9. A welding system comprising at least two welding devices, each adapted to weld at least one work piece, each of the at least two welding devices comprising:
a carriage, adapted to move along a respective one of at least two paths of welding relative to the at least one work piece and therewith, a location of welding, and including a holder configured to accommodate, at least in use an arc generating element; and
a device on the carriage, the device being adapted to locally decrease magnetic fields in or between the at least one work piece, by at least partially suppressing magnetic fields locally at locations of the arc generating elements.

10. The welding system of claim 9, comprising at least one of, arranged on the carriage in close proximity to the arc generating element,
at least one magnet; and
at least one electromagnet.

11. The welding system of claim 9, wherein the at least one of at least one magnet and at least one electromagnet includes at least one of two magnets and at least two electromagnets, arranged on the carriage in close proximity to the arc generating element and each of the two arranged on opposing sides, relative to the location of the arc generating element.

12. The welding system of claim 9, further comprising:
a controller;
an adapter associated with each of the devices for locally suppressing magnetic fields; and
a magnetic field meter adapted to measure a magnetic field at a plurality of points along the path of moving the arc generating element, wherein the controller is adapted to determine, based on magnetic field measurement results from the magnetic field meter, a measure of influencing from the at least one position, expected to suppress the magnetic field at each of the locations of the arc generating element individually for each of the points along the paths of movement of the arc generating element as the arc generating elements approach or are at the points, and wherein the controller is further adapted to drive the adapter for adapting the measure of influencing for each of the devices individually to a determined measure of influencing as the arc generating element reaches the points along the path.

13. The welding system of claim 9, wherein the device adapted for locally suppressing magnetic fields at least partially at each of the locations of the arc generating elements individually comprises at least one connector, adapted to connect parts of the at least one work piece in the vicinity of the weld location, and wherein the connector is of a material exhibiting a relatively high permeability to magnetic fields to divert the magnetic fields to flow through the connector.

14. The method of claim 1, wherein the at least one work piece is a cladded pipe, wherein the at least one arc generating element is a cathode and wherein the magnetic field meter is a Gauss meter.

15. The method of claim 2, wherein decreasing magnetic fields in or between the at least one work piece includes influencing the magnetic fields from at least one position at a relatively short distance from each of the locations of the arc generating elements individually.

16. The method of claim 15, further comprising:
adjusting intensity of the influence at or near the position from the relatively short distance from the arc generating elements.

17. The method of claim 15, further comprising:
varying the relatively short distance from the position of influence to the locations of the arc generating elements.

18. The method of claim 4, further comprising:
varying the relatively short distance from the position of influence to the locations of the arc generating elements.

19. The welding system of claim 10, wherein the at least one of at least one magnet and at least one electromagnet includes at least one of two magnets and at least two electromagnets, arranged on the carriage in close proximity to the arc generating element and each of the two arranged on opposing sides, relative to the location of the arc generating element.

20. The welding system of claim 10, further comprising:
a controller;
an adapter associated with each of the devices for locally suppressing magnetic fields; and
a magnetic field meter adapted to measure a magnetic field at a plurality of points along the path of moving the arc generating element, wherein the controller is adapted to determine, based on magnetic field measurement results from the magnetic field meter, a measure of influencing from the at least one position, expected to suppress the magnetic field at each of the locations of the arc generating element individually for each of the points along the paths of movement of the arc generating element as the arc generating elements approach or are at the points, and wherein the controller is further adapted to drive the adapter for adapting the measure of influencing for each of the devices individually to a determined measure of influencing as the arc generating element reaches the points along the path.
